(19) United States
(12) Patent Application Publication
(10) Pub. No.: US 2016/0088384 A1
(43) Pub. Date: Mar. 24, 2016

(54) HEADPHONE

(71) Applicant: CHENG-HUI CHANG, NEW TAIPET CITY (TW)

(72) Inventor: CHENG-HUI CHANG, NEW TAIPET CITY (TW)

(21) Appl. No.: 14/580,405

(22) Filed: Dec. 23, 2014

(30) Foreign Application Priority Data
Sep. 23, 2014 (TW) 103216867

(51) Int. Cl. H04R 1/10

(52) U.S. Cl. CPC H04R 1/1091

(57) ABSTRACT

A headphone is disclosed, which comprises: a first earpiece, formed with a first receiving groove and a first frame in a manner that the first frame is designed to be received inside the first receiving groove; a second earpiece, formed with a second receiving groove and a second frame in a manner that the second frame is designed to be received inside the second receiving groove; and a coupling unit, mounted respectively to a free end of the first frame and a free end of the second frame. In an embodiment, the first frame, the second frame as well as the coupling unit attached thereto can be received inside the first earpiece and the second earpiece in respective, by that the size of the headphone can be reduced for easy depository and carriage.

### FIELD OF THE INVENTION

The present invention relates to a headphone, and more particularly, to a headphone with a specific design for allowing its frame to be received inside its earpiece in a retractable manner, enabling the portability of headphone to be enhanced and allowing any one of the earpieces of the headphone to be used independently.

### BACKGROUND OF THE INVENTION

Headsets are a pair of loudspeakers that are designed to be held in place close to a user's ears and are capable of receiving signals from a signal source such as an audio amplifier, radio, CD player, portable media player, and converting the signals into sound waves perceivable by human ears. Currently, there are roughly two types of headphones, which are headphones and earphones.

Generally, a common headphone has two earpieces that are connected to each other by a frame, whereas each of the two earpieces is provided for a loudspeaker and related circuits to be embedded therein. As headphones are designed to be worn on user's head, the frame thereof connecting the two earpieces might mess up the user's hair, which could be unacceptable especially for female users.

In addition, by the design of the frame for any common headphones, one headphone is provided to be used only by one user only. Consequently, to sharing one headphone with a friend may be difficult since its two earpieces are connected by the frame and can not be separated.

Moreover, most headphones available on the market are generally designed for adults only without any consideration for children, and consequently, parents can not simply buy one headphone and hopes it can also fit for their young children to use comfortably, as the head size of a child is quite a bit smaller. Furthermore, the size of a common headphone can be comparatively larger by the design of the frame connecting the two earpieces, so that headphones are generally not ease to be carried around.

Therefore, it is in need of a headphone that not only is ease to use, but also is ease to carry.

### SUMMARY OF THE INVENTION

In view of the disadvantages of prior art, the primary object of the present invention is to provide a headphone, capable of enabling its two earpieces to be used independently or simultaneously, and also capable of fitting itself to users of different head sizes by the adjustment of two retractable units embedded respectively inside the two earpieces. Moreover, as the two retractable units can be received inside the two earpieces in respective, the overall size of the headphone can be reduced for easy depository and carriage.

To achieve the above object, the present invention provides a headphone, which comprises: a first earpiece, formed with a first frame that is received inside the first earpiece; a second earpiece, formed with a second frame that is received inside the second earpiece; and a coupling unit, mounted respectively to a free end of the first frame and a free end of the second frame.

In an embodiment, other than mounting on a user's head, each of the first and the second earpieces is designed to be used independently in a handheld manner for allowing the headphone to operate while being held on a user's hand without having the user's hair to be messed up by either the first frame or the second frame.

By the retractable design of the first and the second frames and the cooperation between the two frames, the headphone of the present invention can fit perfectly for users of different head sizes, including adults and children.

As the first frame, the second frame and the coupling unit can be received respectively inside the first earpiece and the second earpiece, the overall size of the headphone can be reduced for easy depository and carriage.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a headphone according to a first embodiment of the present invention.

FIG. 2 is a cross sectional view of a coupling unit used in an embodiment of the present invention.

FIG. 3 is a cross sectional view of a coupling unit used in another embodiment of the present invention.

FIG. 4 is a schematic diagram showing a headphone according to a second embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

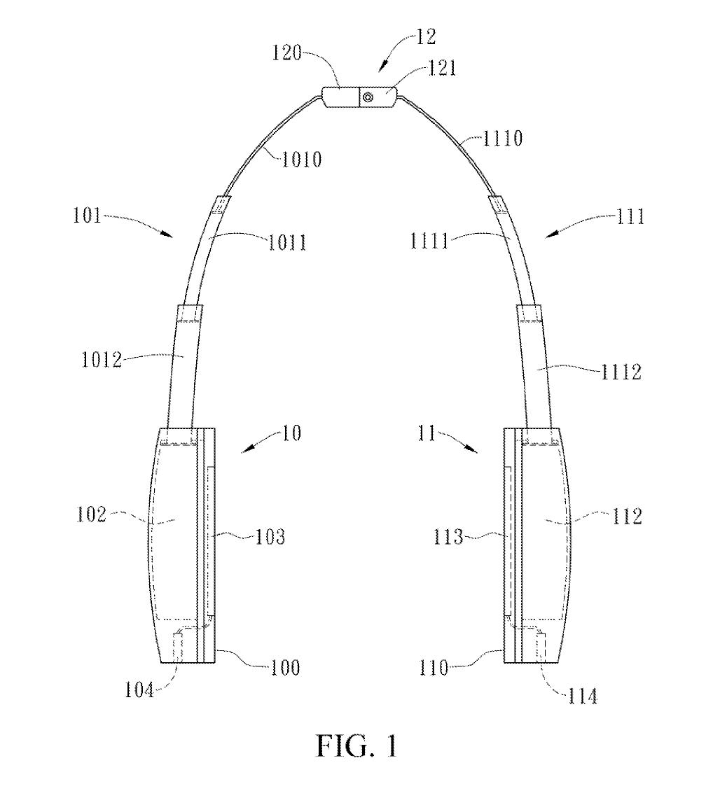

Please refer to FIG. 1, which is a schematic diagram showing a headphone according to a first embodiment of the present invention. In FIG. 1, the headphone comprises: a first earpiece 10, a second earpiece 11 and a coupling unit 12.

The first earpiece 10 further comprises a first shell 100 and a first frame 101. The first shell 100 is further formed with a first receiving groove 102. In addition, the first shell 100 is provided for receiving a first loudspeaker 103 therein while allowing the first loudspeaker 103 to connect electrically to a cable that is extending outside the first shell 100 and connected electrically to a media player, and thereby enabling a sound wave to be broadcast out of the loudspeaker 103. In the embodiment, the first shell 100 is further formed with a first sharing socket 104, that is electrically connecting to the first loudspeaker 103.

Moreover, the first frame 101 is composed of: a first sliding block spring 1010, a second sliding block spring 1011 and a third sliding block spring 1012 in a manner that the first sliding block spring 1010 is received inside the second sliding block spring 1011 while the second sliding block spring 1011 is received inside the third sliding block spring 1012. In this embodiment, as the first frame 101 is designed to be received inside the first earpiece 10, the first frame 101 is actually received inside the first receiving groove 102.

The second earpiece 11 further comprises a second shell 110 and a second frame 111. The second shell 110 is further formed with a second receiving groove 112. In addition, the second shell 110 is provided for receiving a second loudspeaker 113 therein while allowing the second loudspeaker 113 to connect electrically to a cable that is extending outside the second shell 110. In the embodiment, the second shell 110 is further formed with a second sharing socket 114, that is electrically connecting to the second loudspeaker 113.

The second frame 111 is composed of: a first sliding block spring 1110, a second sliding block spring 1111 and a third sliding block spring 1112 in a manner that the first sliding block spring 1110 is received inside the second sliding block spring 1111 while the second sliding block spring 1111 is received inside the third sliding block spring 1112. In this embodiment, as the second frame 111 is designed to be received inside the second earpiece 11, the second frame 111 is actually received inside the second receiving groove 112.

To sum up, each of the first and the second frames 101, 111 can be composed of a plurality of sliding block springs, and the first and the second frames 101, 111 are received respectively inside the first and the second receiving grooves 102, 112.

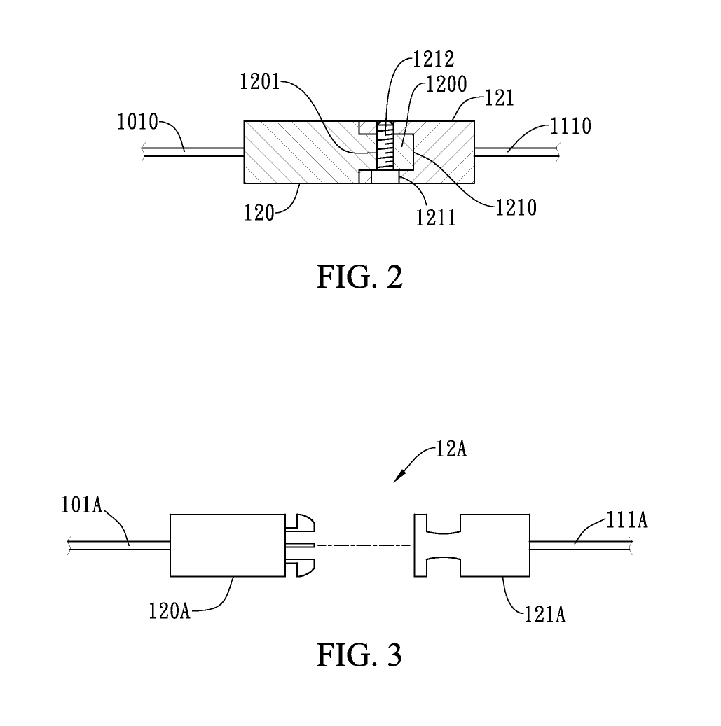

Please refer to FIG. 2, which is a cross sectional view of a coupling unit used in an embodiment of the present invention. In FIG. 2, the coupling unit 12 is configured with a first base 120 and a second base 121 in a manner that the first base 120 is formed with a positioning block 1200 arranged at an end thereof and a fixing hole 1201, while allowing the first base 120 to be disposed at the free end of the first frame 101; and the second base 121 is formed with a positioning slot 1210 arranged at a position corresponding to the positioning block 1200 for allowing the positioning block 1200 to fit therein, and a via hole 1211 disposed at a position corresponding to the fixing hole 1201 while allowing a fixing piece 1212 to pierce through the via hole 1211 and then fixed to the fixing hole 1201, and thus allowing the second base 121 to be disposed at the free end of the second frame 111. Thereby, the first base 120 is coupled to the second base 121, so that the first frame 101 is connected to the second frame 111. In an embodiment of the present invention, the fixing piece 1212 is a bolt and the fixing hole 1201 is a screw hole.

With reference to FIG. 1, when the positioning block 1200 is fitted into the positioning slot 1210 for fixing the relative positioning of the first base 120 and the second base 121, the fixing piece 121 can then be used for coupling the first base 120 to the second base 121.

It is noted that by the coupling of the first base 120 and the second base 121, the first earpiece 10 is connected to the second earpiece 11. When the abovementioned headphone is worn by an adult, the first frame 101 and the second frame 111 are generally fully stretched while allowing the first earpiece 10 and the second earpiece 11 to attached tightly to the user's ears in respective by the elasticity of the first and the second frames 101, 111.

As the first and the second loudspeakers 103, 113 are electrically connected to a media player by a cable, electric signals from the media player can be sent to the first and the second loudspeakers 103, 113, where they are converted into sound waves for broadcasting out of the first and the second loudspeakers 103, 113.

When the abovementioned headphone is worn by a child with comparatively smaller head, the first frame 101 and the second frame 111 can retract and match the head size of the child so that the headphone can fit comfortable to the child with smaller head.

Nevertheless, in a condition when the user is worrying that his/her hair might be massed up by the headphone and is hesitated to wear the headphone on his/her head, the fixing piece 1212 can be detached and removed from the via hole 1211 and the fixing hole 1201 for enabling the first base 120 and the second base 121 of the coupling unit 12 to be detached and separated from each other.

Thereby, the first frame 101 and the first base 120 can be retracted and received inside the first receiving groove 102, and similarly, the second frame 111 and the second base 121 can be retracted and received inside the second receiving groove 112. Consequently, it is possible for the user to hold onto either the first earpiece 10 or the second earpiece 11 next to his/her ear for listening to the sound waves.

Operationally, when the user intends for sharing the sound waves to another user, the user can simple plug the cable from another headphone into either the first sharing socket 104 or the second sharing socket 114, so that the sound waves can be hear from such another headphone.

Please refer to FIG. 3, which is a cross sectional view of a coupling unit used in another embodiment of the present invention. In this second embodiment, the first and the second earpieces are structured the same as the first embodiment, and thus will not be described further herein.

In this second embodiment, the coupling unit 12A is composed of a male buckle 120A and a female buckle 121A. In addition, the male buckle 12A is disposed at the free end of the first frame 101A, while the female buckle 121A is disposed at the free end of the second frame 111A.

When the male buckle 120A and the female buckle 121A are engaged and snapped to each other, the first earpiece is connected to the second earpiece. On the other hand, when the male buckle 120A and the female buckle 121A are not engaged, the first earpiece and the second earpiece are separated from each other.

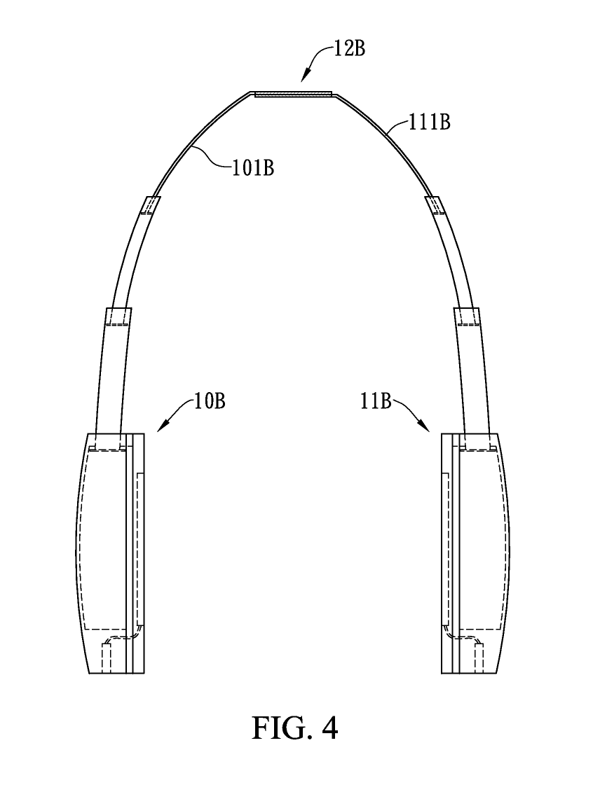

Please refer to FIG. 4, which is a schematic diagram showing a headphone according to a second embodiment of the present invention. In FIG. 4, the coupling unit 12B is substantially a Velcro tape, that are disposed attaching respectively to the free end of the first frame 101B and the free end of the second frame 111B. Operationally, the first earpiece 10B and the second earpiece 11B can be connected to each other or separated from each other simply by the attaching or detaching of the Velcro tape.

To sum up, as each of the first and the second earpieces is composed of a plurality of sliding block springs, while each of the plural sliding block springs is made of a pseudo-plastic material, the first and the second earpieces are elastic members while the plural sliding block springs are arranged for allowing then to be stretched or retracted sequentially, the length of each of the first and the second earpieces can be adjusted in a multi-stage manner.

Moreover, as the first frame, the second frame and the coupling unit can be received respectively inside the first earpiece and the second earpiece, the overall size of the headphone can be reduced for easy depository and carriage.

As the first earpiece and the second earpiece can be separated from each other, any one of them can be used independently. In addition, as each of the first and the second earpieces are formed with a sharing socket that is provided for another headphone to connected thereto for sharing the same sound source.

In the present invention, it is possible for the user to hold onto either the first earpiece 10 or the second earpiece 11 next to his/her ear for listening to the sound waves. That is, the headphone of the present invention can operate smoothly no matter it is being handheld or head-mounted. While being held on hand, the first frame and the second frame can be retracted and received respectively inside the first receiving groove and the second receiving groove 112 for preventing the holding of the headphone from the interference of the first and the second frames.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A headphone, comprising:
a first earpiece, formed with a first frame that is received inside the first earpiece;
a second earpiece, formed with a second frame that is received inside the second earpiece; and
a coupling unit, mounted respectively to a free end of the first frame and a free end of the second frame.

2. The headphone of claim 1, wherein each of the first and the second earpieces is composed of a plurality of sliding block springs, while each of the plural sliding block springs is made of a pseudo-plastic material.

3. The headphone of claim 1, wherein the coupling unit is configured with a first base and a second base in a manner that the first base is formed with a positioning block arranged at an end thereof and a fixing hole, while allowing the first base to be disposed at the free end of the first frame; and the second base is formed with a positioning slot arranged at a position corresponding to the positioning block for allowing the positioning block to fit therein, and a via hole disposed at a position corresponding to the fixing hole while allowing a fixing piece to pierce through the via hole and then fixed to the fixing hole, and thus allowing the second base to be disposed at the free end of the second frame.

4. The headphone of claim 3, wherein the fixing piece is a bolt and the fixing hole is a screw hole.

5. The headphone of claim 1, wherein the coupling unit is a Velcro tape, and the Velcro tape is attached respectively to the free end of the first frame and the free end of the second frame.

6. The headphone of claim 1, wherein the coupling unit is an assembly of a male buckle and a female buckle, while the male buckle is disposed at the free end of the first frame and the female buckle is disposed at the free end of the second frame.
